(19) United States
(12) Patent Application Publication
(10) Pub. No.: US 2005/0177717 A1
(43) Pub. Date: Aug. 11, 2005

(54) Method and apparatus for defending against denial on service attacks which employ IP source spoofing

(76) Inventor: Eric Henry Grosse, Berkeley Heights, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/776,719

(22) Filed: Feb. 11, 2004

(51) Int. Cl. H04L 9/32

(52) U.S. Cl. 713/160; 713/201

(57) ABSTRACT

A method and apparatus for defending against denial of service (DoS) attacks which employ IP (Internet Protocol) address spoofing. In accordance with an illustrative embodiment of the invention, a carrier offers a “premium” service which comprises marking IP data packets based on whether it has in fact been able to verify the accuracy of the specified IP source address. This marking flag may be implemented with use of a zero/non-zero Type-of-Service (TOS) field value in the IP header, and verification of the source address may be performed with use of a Reverse Path Forwarding (RPF) or other similar such test. The “premium” service is referred to herein as “IP CallerID.”

### FIELD OF THE INVENTION

The present invention relates generally to the field of Internet security and more particularly to the problem of defending against denial of service (DoS) attacks which employ IP (Internet Protocol) address spoofing.

### BACKGROUND OF THE INVENTION

In today's Internet, when a packet is delivered from a carrier to a customer, there is no accurate information about where it came from. The source IP address in the packet header can be (and in denial of service attacks, frequently is) forged. There have been several attempts in the past at solving this problem.

One prior art solution is for the customer (perhaps as a managed service) to install IPsec VPN (Virtual Private Network) hardware, familiar to those of ordinary skill in the art, effectively creating a point-to-point path across the Internet by means of encryption. This is secure, although effort must still be expended to discover and discard malicious packets.

A second prior art solution is the use of the BGP (Border Gateway Protocol) VPN, in which customer-specific virtual routers are used to segregate traffic. This can also work, though complexity is generally regarded as the enemy of security and the substantial extensions to BGP involved are anything but simple.

A third prior art solution is for the carrier to provide perfect ingress filtering, as is well known and described, for example, in IETF (Internet Engineering Task Force) RFC (Request for Comments) 2267. In practice, what this would mean is that the carrier would have a set of addresses for its customers spanning a certain range. At each customer connection, only packets with source addresses belonging to that customer would be allowed to enter. At peering connections to the rest of the Internet, any incoming packets with source addresses in the carrier's range would be dropped. In this way, a customer could depend on the source address of a packet that it receives, as long as the address is in the correct range.

There are sometimes legitimate uses for forged packets, however, so a dogmatic implementation of ingress filtering will lead to problems, though probably fewer than are already caused by Network Address Translation. The much more difficult problem is that universal deployment by carriers worldwide is very far off, if it is even possible (logistically). Some of the reasons that ingress filtering is not popular include (i) it provides no revenue stream to the carrier; (ii) carriers are concerned about asymmetric routing; and (iii) it is ineffective unless it is very widely deployed.

### SUMMARY OF THE INVENTION

The present invention provides a novel solution to the above-described problem—one which can advantageously be incrementally deployed. In accordance with certain illustrative embodiments of the present invention, a carrier offers a “premium” service which comprises marking packets for which it has in fact been able to verify the source address. According to one such embodiment, this marking flag is implemented by setting the Type-of-Service (TOS) field in the IP header to a non-zero value if and only if the source address of the packet has been verified. Note that, as used herein, the terms “marking” and “setting” of a “flag” or a data “field” merely signify the act of “ensuring” that the given flag or data field does in fact contain the desired value (e.g., zero or non-zero), regardless of whether the desired value is actively written to the flag or data field or whether the current value of the flag or data field is first checked and then overwritten only if the current value is not the desired value. Also note that we will refer to such a (premium) service herein as “IP CallerID” because it accurately identifies (i.e., verifies) the source address of an IP packet in a similar sense to that of conventional telephony CallerID which identifies the source address (i.e., telephone number) of a telephone call.

For example, in accordance with one illustrative embodiment of the present invention, any packets entering the carrier's network from customer access links that fail to pass a Reverse Path Forwarding (RPF) or other test would advantageously have the TOS field thereof set to a zero value, while packets which do pass such a test would advantageously have the TOS field thereof set to a non-zero value. (As is fully familiar to those of ordinary skill in the art, a Reverse Path Forwarding test comprises checking at a network ingress port that an incoming packet having a given identified source address is, in fact, being received on the same port that it would have been routed out to, if it were instead an outgoing packet having a destination address equal to its identified source address.) Also, in accordance with one illustrative embodiment of the present invention, a non-zero value (e.g., a value of one) is written to the TOS field if it has passed the RPF (or other) test only if the TOS field has not already been set to some non-zero value (for quality of service purposes, for example). In this manner, when the TOS field is being used to specify a type of service request, it will only become ineffective in that regard if the source address cannot in fact be verified.

Moreover, in accordance with one illustrative embodiment of the present invention, packets coming from a peer carrier that also implements an embodiment of the present invention would be advantageously accepted without further checks. Packets from a non-participating peer carrier, however, would advantageously have the TOS field set to zero, since the originating source address could not be verified in such a case.

In accordance with the above-described illustrative embodiments of the present invention, one modest side effect resulting from the use of the instant technique may be to penalize packets that are or might be forged and yet want to have high quality-of-service. But, advantageously, no packets at all are dropped by the network, and therefore no existing applications will be broken, unlike, for example, the more stringent ingress filtering prior art approach described above (and in IETF RFC 2267).

Note that the most expensive part of implementing the above-described illustrative embodiment of the present invention is the RPF (or other) test of incoming packets on access lines, but routers already exist that implement this efficiently. Note also that the implementation of an embodiment of the present invention is not incompatible with certain ones of the above-described prior art approaches, such as, for example, the use of IPsec, and indeed, use of the present invention may make it easier to defend IPsec tunnels against denial of service attacks.

### BRIEF DESCRIPTION OF THE DRAWINGS

FIG. 1 shows an illustrative structure of a typical IP (Internet Protocol) data packet which may be routed with use of an IP CallerID service in accordance with an illustrative embodiment of the present invention.

FIG. 2 shows an illustrative network environment comprising two carriers which offer an IP CallerID service in accordance with an illustrative embodiment of the present invention.

FIG. 3 shows a flowchart of an illustrative method for processing an incoming packet to provide an IP CallerID service in accordance with an illustrative embodiment of the present invention.

FIG. 4 shows a flowchart of an illustrative method for processing a packet received at a destination in accordance with an illustrative embodiment of the present invention, wherein the packet has been advantageously processed by a carrier providing an IP CallerID service in accordance with an illustrative embodiment of the present invention such as that of the illustrative method shown in FIG. 3.

### DETAILED DESCRIPTION OF THE ILLUSTRATIVE EMBODIMENTS

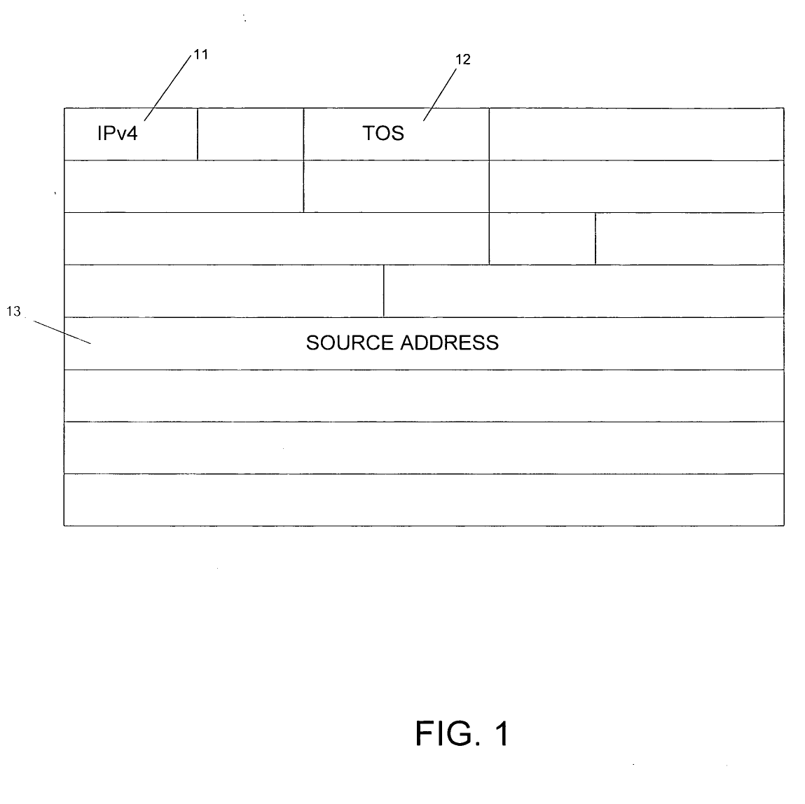

FIG. 1 shows an illustrative structure of a typical IP (Internet Protocol) data packet which may be routed with use of an IP CallerID service in accordance with an illustrative embodiment of the present invention. The illustrative IP data packet begins with an indication in data field 11 that the packet is an IPv4 (version 4) protocol data packet. Data field 12 comprises a Type-of-Service (TOS) value which may, in some illustrative embodiments of the present invention, be used by the sender to indicate quality of service information (i.e., a desired or required quality of service level provided by the sender). In other illustrative embodiments of the present invention (e.g., where quality of service information is not provided), the TOS field may simply be left blank by the sender.

Finally, in data field 13 of the illustrative IP data packet, the source address is specified. This address is supposed to identify the originating IP address of the packet. However, in certain situations, such as when the packet is generated maliciously from a denial of service attack which employs IP address spoofing, the source address indicated in data field 13 may, in fact, be erroneous (“spoofed”).

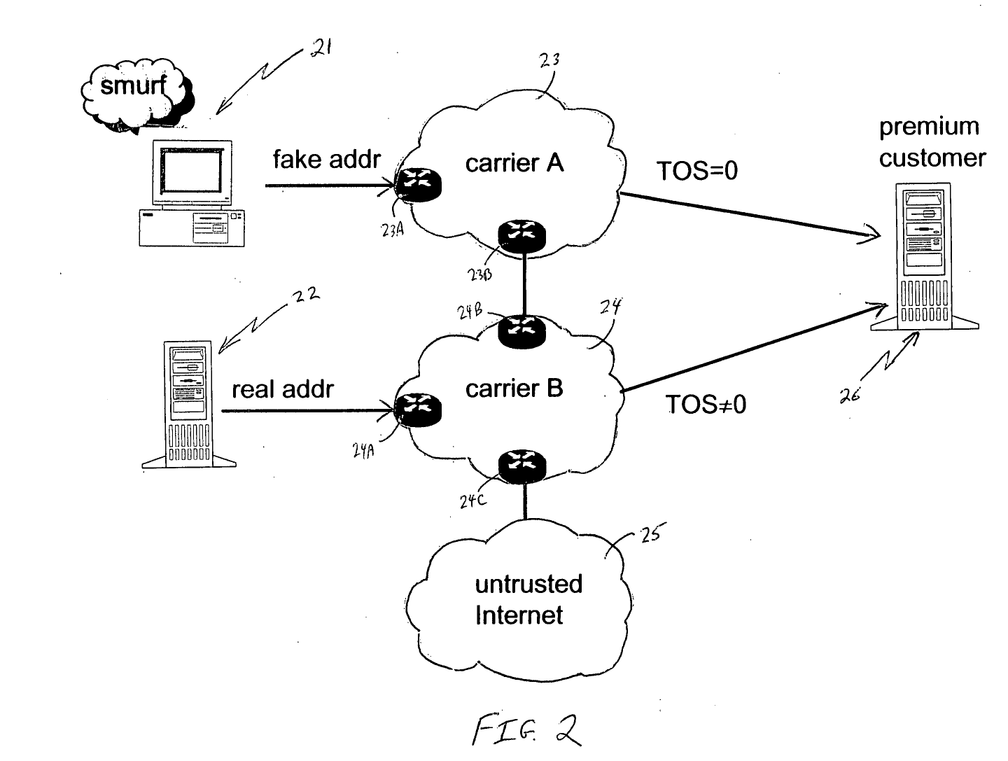

FIG. 2 shows an illustrative network environment comprising two carriers which offer an IP CallerID service in accordance with an illustrative embodiment of the present invention. The illustrative environment shown in the figure includes (malicious) “smurfer” 21 who, for example, is attempting to perpetrate a denial of service attack by sending IP packets with fake (“smurfed”) source addresses into network 23 of carrier A. Specifically, these packets are received by edge (periphery) router 23A of network 23. Network edge router 23A (as well as all of the other network edge routers shown in the figure) may be a Border Gateway Protocol (BGP) router, fully familiar to those of ordinary skill in the art.

Meanwhile, (legitimate) system 22 is sending legitimate IP packets having real (i.e., correct) source addresses into network 24 of carrier B. Specifically, these packets are received by edge (periphery) router 24A of network 24. In addition, there is the possibility that IP packets arrive in general from (untrusted) Internet 25 and are received, for example, by edge (periphery) router 24C of network 24. (Edge routers 23B and 24B are also shown in the figure—they may be used for the exchange of IP packets between network 23 and network 24 as needed.)

In accordance with the illustrative embodiment of the present invention, carrier A and carrier B offer a “premium” IP CallerID service to (premium) customer 26. In particular, IP packets forwarded to customer 26 will have their TOS data field set to a non-zero value if and only if the source address identified in the packet has been “verified.” As shown, “smurfed” IP packets sent, for example, by (malicious) smurfer 21, will be forwarded to customer 26 with their corresponding TOS fields set to a value of zero, while legitimate packets sent, for example, by (legitimate) system 22, will be forwarded to customer 26 with their corresponding TOS fields set to a non-zero value.

Note that in other illustrative embodiments of the present invention, data fields other than the TOS field may be used to provide an indication of whether the source address has been verified or not. For example, any otherwise unused field (of one or more bits) in the IP data packet may be used as a “flag” which is set to zero or non-zero (e.g., one) based on whether the source address has been verified or not.

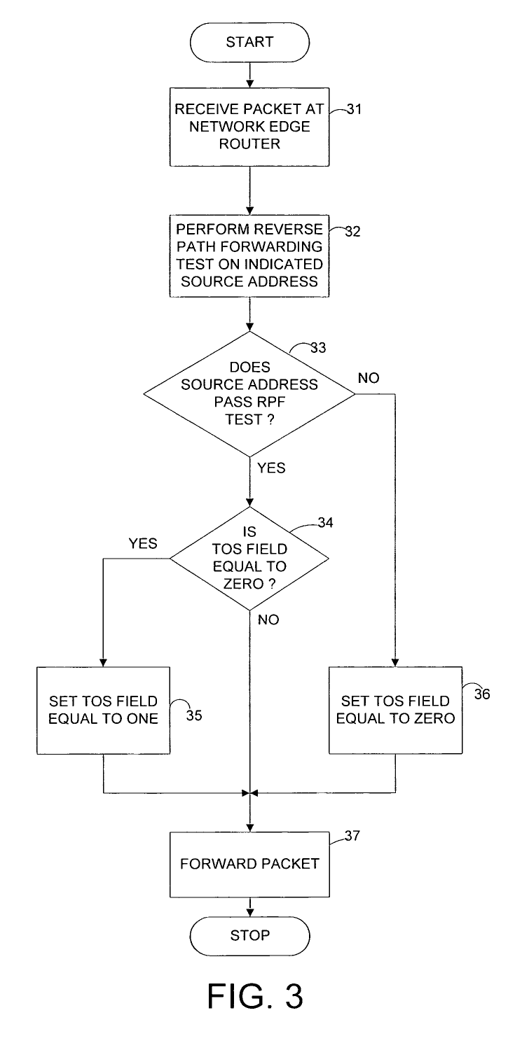

FIG. 3 shows a flowchart of an illustrative method for processing an incoming packet to provide an IP CallerID service in accordance with an illustrative embodiment of the present invention. The illustrative method of FIG. 3 may be advantageously employed by a network edge (periphery) router in response to the network receiving an incoming IP packet.

Specifically, after an IP packet is received by the edge router (as shown in block 31 of the figure), an RPF (Reverse Path Forwarding) test or other similar such test is performed to verify whether the given IP packet has, in fact, come from the identified source address (as shown in block 32 of the figure). (Reverse Path Forwarding tests are conventional and fully familiar to those of ordinary skill in the art.) Decision 33 determines whether the RPF (or other) test has succeeded, and if not, block 36 sets the TOS field equal to a value of zero. If the source address does, in fact, pass the RPF (or other) test, decision 34 determines whether the TOS field has a zero value, and if so, block 35 sets the value of the TOS field equal to one. Finally, the packet is forwarded (block 37 of the figure) with the TOS field set to a non-zero or zero value based on whether the source address has been verified or not.

Note that if the TOS field is being used for quality of service purposes, then in accordance with this illustrative embodiment of the present invention, any non-zero TOS value provided by the sender will not be disturbed as long as the source address can be verified. In other words, only unverified IP packets will lose their indicia of required or requested quality of service treatment. Also note that, as described above, in accordance with other illustrative embodiments of the present invention, a data field of the IP data packet other than the TOS field may be used to indicate whether the source address has been verified or not.

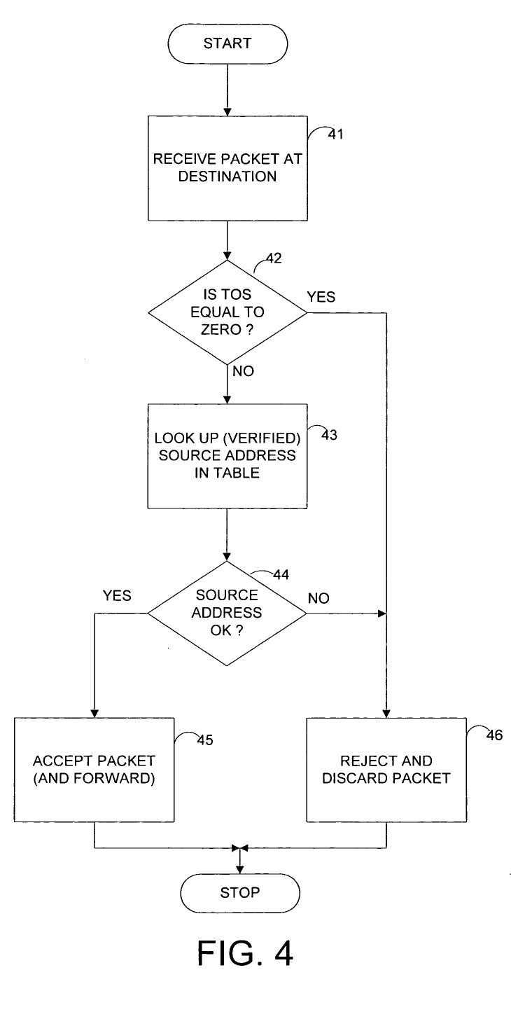

FIG. 4 shows a flowchart of an illustrative method for processing a packet received at a destination in accordance with an illustrative embodiment of the present invention, wherein the packet has been advantageously processed by a carrier providing an IP CallerID service in accordance with an illustrative embodiment of the present invention such as that of the illustrative method shown in FIG. 3. The packet is received by block 41 and decision 42 checks the value of the TOS field in the received packet. If the TOS field value is equal to zero, the packet is rejected and discarded (block 46) since the IP source address has not been verified.

If, on the other hand, the TOS field is not equal to zero, the (verified) source address is looked up in a table (block 43) which advantageously contains acceptable and/or unacceptable known addresses. Decision 44 then determines whether the source address is acceptable or unacceptable based on the lookup performed in block 43. If it is acceptable, the packet is accepted and forwarded (block 45). Otherwise, it is rejected and discarded (block 46).

Note that in accordance with certain illustrative embodiments of the present invention, the table lookup of the illustrative method shown in FIG. 4 is not performed. Rather, the packet is accepted (and forwarded) or rejected (and discarded) based solely on whether the TOS field value is equal to zero or not equal to zero. And in certain other illustrative embodiments of the present invention, all received packets are accepted (and forwarded), regardless of the value of the TOS field. However, in accordance with these embodiments, the data packets are advantageously prioritized based on whether the source address has been verified or not (e.g., whether the TOS field value is equal to zero or not equal to zero). In this manner, no packets whatsoever are lost, but “smurfed” packets such as those sent as apart of a denial of service attack will be given lower priority and thus will be quite ineffective at interfering with the handling of legitimate data packets (which is the goal of a denial of service attack).

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

1. A method of authenticating indicated IP source addresses comprised in IP data packets to be transmitted through an IP network, the method comprising the steps of:
receiving an IP data packet at an incoming edge of an IP network, the IP data packet comprising an indicated IP source address;
determining whether said IP data packet having been received at said incoming edge of the IP network is consistent with it having originated at said indicated IP source address;
ensuring that a predetermined data field of said IP data packet contains a value representative of whether said IP data packet having been received at said incoming edge of the IP network is consistent with it having originated at said indicated IP source address.

2. The method of claim 1 wherein the step of determining whether said IP data packet having been received at said incoming edge of the IP network is consistent with it having originated at said indicated IP source address comprises performing a Reverse Path Forwarding test on said IP data packet.

3. The method of claim 1 wherein said predetermined data field of said IP data packet comprises an otherwise unused data field of said IP data packet.

4. The method of claim 1 wherein said predetermined data field of said IP data packet comprises a Type of Service data field.

5. The method of claim 4 wherein said step of ensuring that said predetermined field of said IP data packet contains a value representative of whether said IP data packet having been received at said incoming edge of the IP network is consistent with it having originated at said indicated IP source address comprises
ensuring that the Type of Service data field contains a zero value if said IP data packet having been received at said incoming edge of the IP network is not consistent with it having originated at said indicated IP source address, and
ensuring that the Type of Service data field contains a non-zero value if said IP data packet having been received at said incoming edge of the IP network is consistent with it having originated at said indicated IP source address.

6. The method of claim 5 wherein said ensuring that the Type of Service field contains a non-zero value if said IP data packet having been received at said incoming edge of the IP network is consistent with it having originated at said indicated IP source address comprises the steps of
determining if the Type of Service field already has a non-zero value, and
modifying the Type of Service field to have a non-zero value only if it does not already have a non-zero value.

7. The method of claim 1 wherein the step of determining whether said IP data packet having been received at said incoming edge of the IP network is consistent with it having originated at said indicated IP source address comprises
determining whether said IP data packet having been received at said incoming edge of the IP network has been received from a peer carrier which has already determined whether said IP data packet having been received at said incoming edge of the IP network is consistent with it having originated at said indicated IP source address, and
ensuring that the predetermined data field of said IP data packet contains a value representative of whether said IP data packet having been received at said incoming edge of the IP network was determined by said peer carrier to be consistent with it having originated at said indicated IP source address.

8. A method of processing IP data packets received from an IP network, the IP data packets comprising indicated IP source addresses and one or more of the IP data packets having been marked with indicia of whether the indicated IP source address comprised therein has been authenticated by the IP network, the method comprising the steps of:
determining whether the indicated IP source address comprised in each one of said one or more of the IP data packets has been authenticated by the IP network; and
processing each one of the one or more of the IP data packets based on whether the indicated IP source address comprised therein has been authenticated by the IP network.

9. The method of claim 8 wherein said indicia of whether the indicated IP source address comprised in said one or more of the IP data packets has been authenticated by the IP network comprises a value contained in a predetermined data field of each of said IP data packets.

10. The method of claim 9 wherein said predetermined data field of each of said IP data packets comprises an otherwise unused data field of said IP data packets.

11. The method of claim 9 wherein said predetermined data field of each of said IP data packets comprises a Type of Service data field.

12. The method of claim 11 wherein said Type of Service data field comprised in each of said one or more IP data packets contains a zero value for each of said one or more IP data packets for which the indicated IP source address comprised therein has not been authenticated by the IP network, and contains a non-zero value for each of said one or more IP data packets for which the indicated IP source address comprised therein has been authenticated by the IP network.

13. The method of claim 8 wherein the step of processing each one of the one or more of the IP data packets based on whether the indicated IP source address comprised therein has been authenticated by the IP network comprises discarding each of said one or more IP data packets for which the indicated IP source address comprised therein has not been authenticated by the IP network.

14. The method of claim 13 further comprising the step of performing a look up of one or more indicated IP source addresses comprised in one or more corresponding IP data packets which have been authenticated by the IP network, and wherein the step of processing each one of the one or more of the IP data packets based on whether the indicated IP source address comprised therein has been authenticated by the IP network further comprises discarding one or more of said IP data packets for which the indicated IP source address comprised therein has been authenticated by the IP network based on said look up of said one or more indicated IP source addresses comprised in one or more corresponding IP data packets which have been authenticated by the IP network.

15. The method of claim 8 wherein the step of processing each one of the one or more of the IP data packets based on whether the indicated IP source address comprised therein has been authenticated by the IP network comprises prioritizing the one or more of the IP data packets based on whether the indicated IP source address comprised therein has been authenticated by the IP network, said IP data packets for which the indicated IP source address comprised therein has been authenticated by the IP network having a higher priority than said IP data packets for which the indicated IP source address comprised therein has not been authenticated by the IP network.

16. A network edge router located at an incoming edge of an IP network, the router adapted to authenticate indicated IP source addresses comprised in IP data packets to be transmitted through the IP network, the router comprising:
an input port which receives an IP data packet at the incoming edge of the IP network, the IP data packet comprising an indicated IP source address;
means for determining whether said IP data packet having been received at said incoming edge of the ]P network is consistent with it having originated at said indicated IP source address;
means for ensuring that a predetermined data field of said IP data packet contains a value representative of whether said IP data packet having been received at said incoming edge of the IP network is consistent with it having originated at said indicated IP source address.

17. The router of claim 16 wherein the means for determining whether said IP data packet having been received at said incoming edge of the IP network is consistent with it having originated at said indicated IP source address comprises means for performing a Reverse Path Forwarding test on said IP data packet.

18. The router of claim 16 wherein said predetermined data field of said IP data packet comprises an otherwise unused data field of said IP data packet.

19. The router of claim 16 wherein said predetermined data field of said IP data packet comprises a Type of Service data field.

20. The router of claim 19 wherein said means for ensuring that said predetermined field of said IP data packet contains a value representative of whether said IP data packet having been received at said incoming edge of the IP network is consistent with it having originated at said indicated IP source address comprises
means for ensuring that the Type of Service data field contains a zero value if said IP data packet having been received at said incoming edge of the IP network is not consistent with it having originated at said indicated IP source address, and
means for ensuring that the Type of Service data field contains a non-zero value if said IP data packet having been received at said incoming edge of the IP network is consistent with it having originated at said indicated IP source address.

21. The router of claim 20 wherein said means for ensuring that the Type of Service field contains a non-zero value if said IP data packet having been received at said incoming edge of the IP network is consistent with it having originated at said indicated IP source address comprises
means for determining if the Type of Service field already has a non-zero value, and
means for modifying the Type of Service field to have a non-zero value only if it does not already have a non-zero value.

22. The router of claim 16 wherein the means for determining whether said IP data packet having been received at said incoming edge of the IP network is consistent with it having originated at said indicated IP source address comprises
means for determining whether said IP data packet having been received at said incoming edge of the IP network has been received from a peer carrier which has already determined whether said IP data packet having been received at said incoming edge of the IP network is consistent with it having originated at said indicated IP source address, and
means for ensuring that the predetermined data field of said IP data packet contains a value representative of whether said IP data packet having been received at said incoming edge of the IP network was determined by said peer carrier to be consistent with it having originated at said indicated IP source address.

23. A server adapted to process IP data packets received from an IP network, the IP data packets comprising indicated IP source addresses and one or more of the IP data packets having been marked with indicia of whether the indicated IP source address comprised therein has been authenticated by the IP network, the server comprising:
means for determining whether the indicated IP source address comprised in each one of said one or more of the IP data packets has been authenticated by the IP network; and
means for processing each one of the one or more of the IP data packets based on whether the indicated IP source address comprised therein has been authenticated by the IP network.

24. The server of claim 23 wherein said indicia of whether the indicated IP source address comprised in said one or more of the IP data packets has been authenticated by the IP network comprises a value contained in a predetermined data field of each of said IP data packets.

25. The server of claim 24 wherein said predetermined data field of each of said IP data packets comprises an otherwise unused data field of said IP data packets.

26. The server of claim 24 wherein said predetermined data field of each of said IP data packets comprises a Type of Service data field.

27. The server of claim 26 wherein said Type of Service data field comprised in each of said one or more IP data packets contains a zero value for each of said one or more IP data packets for which the indicated IP source address comprised therein has not been authenticated by the IP network, and contains a non-zero value for each of said one or more IP data packets for which the indicated IP source address comprised therein has been authenticated by the IP network.

28. The server of claim 23 wherein the means for processing each one of the one or more of the IP data packets based on whether the indicated IP source address comprised therein has been authenticated by the IP network comprises means for discarding each of said one or more IP data packets for which the indicated IP source address comprised therein has not been authenticated by the IP network.

29. The server of claim 28 further comprising means for performing a look up of one or more indicated IP source addresses comprised in one or more corresponding IP data packets which have been authenticated by the IP network, and wherein the means for processing each one of the one or more of the IP data packets based on whether the indicated IP source address comprised therein has been authenticated by the IP network further comprises means for discarding one or more of said IP data packets for which the indicated IP source address comprised therein has been authenticated by the IP network based on said look up of said one or more indicated IP source addresses comprised in one or more corresponding IP data packets which have been authenticated by the IP network.

30. The server of claim 23 wherein the means for processing each one of the one or more of the IP data packets based on whether the indicated IP source address comprised therein has been authenticated by the IP network comprises means for prioritizing the one or more of the IP data packets based on whether the indicated IP source address comprised therein has been authenticated by the IP network, said IP data packets for which the indicated IP source address comprised therein has been authenticated by the IP network having a higher priority than said IP data packets for which the indicated IP source address comprised therein has not been authenticated by the IP network.
